(19) United States
(12) Patent Application Publication
(10) Pub. No.: US 2003/0009280 A1
(43) Pub. Date: Jan. 9, 2003

(54) Navigation method and navigation system

(75) Inventor: Frank Hagebarth, Kirchheim (JP)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/167,657

(22) Filed: Jun. 13, 2002

(30) Foreign Application Priority Data
Jul. 5, 2001 (JP) 01 440 205.1

(51) Int. Cl. G01C 21/32

(52) U.S. Cl. 701/209; 340/990; 340/995

(57) ABSTRACT

In a navigation system, particularly for vehicles, with means for position determination, a navigation terminal comprises an operating facility, a display facility, an announcement memory and a transmitter/receiver and is connected, at least intermittently, to a central computer. A navigation system with such a navigation terminal is particularly cost-effective since there is no need for data on the traffic network (road maps) to be stored in the navigation terminal.

### BACKGROUND OF THE INVENTION

The invention is based on a priority application EP 01 440 205.1 which is hereby incorporated by reference. The invention concerns a method for navigating by means of a user-side navigation terminal, particularly of vehicles, in which such a navigation terminal is located, and a navigation system.

Known navigation systems in vehicles contain the data of the vehicle network of a particular region. This data is normally stored on exchangeable data media (e.g. CD-ROM, DVD). The systems generally have a GPS receiver for position determination.

The user enters the journey destination on the device. From the stored data on the route network, the system determines the optimum route and guides the user or driver to the journey destination by means of visual displays or acoustic announcements.

In modern systems, the route guidance takes account of the current traffic situation. Sensors for monitoring the traffic flow on roads and at traffic intersections have been and are being used for this purpose, at great expense.

Furthermore, there are methods in which the vehicles themselves are fitted with sensors. The floating-car method (FCD) may be cited as an example. In the case of this interactive traffic information system, each participating vehicle sends data on location, speed and road conditions to a central computer unit. This data is used to compile a current picture of the traffic situation in each region which is broadcast for information for each vehicle.

The connection between the navigation system in the vehicle and the central computer, which provides information on the current traffic situation, is normally established via a mobile telephony network.

### SUMMARY OF THE INVENTION

The object of the present invention is to provide a cost-effective method for navigating and a flexible, cost-effective navigation system.

This object is achieved, according to the invention, by a method for navigating in which a travel destination is first selected from a list, via the navigation terminal. The selected travel destination and the current location are then transmitted to a remotely located central computer. One or more travel routes and/or the corresponding travel time are calculated by the central computer. Finally, the travel route and/or the travel time are transmitted to the navigation terminal by the central computer.

The list of travel destinations is stored either in the navigation terminal itself or in the central computer. The travel destination can then be selected by specifying a place name, a street and, possibly, a house number. The fact that the travel destination is transmitted to a central computer and the travel route is calculated by the central computer enables the navigation terminal to be produced at relatively low cost, since there is no need for travel routes to be stored in the navigation terminal. Moreover, there are no particularly high demands in respect of the computing power of the navigation terminal. A further advantage is that only the central computer needs to be updated with new route data, and updating of the terminal is not necessary. In particular, if the data of the central computer is updated frequently, the current traffic situation can be included in the route calculation. This flexibility is scarcely possible with conventional navigating methods. It is also conceivable for several routes to be calculated, from which the user can select one.

In the case of a method variant, the travel route is calculated with regard to conditions entered in the navigation terminal by the user. This possibility enables the user to individually organize his travel route. Thus, for example, the user can specify to the central computer, for the purpose of travel route calculation, that the route is not to include any motorways, or that a travel route is to be selected for optimum fuel economy.

In a preferred method variant, the position of the navigation terminal is determined. This measure permits monitoring of the progress of the journey and enables the travel route to be adapted, during travel, to the current traffic situation if necessary. Position determination is preferably effected via a GPS receiver. In any case, according to the invention, another navigation system which evaluates signals broadcast by satellites (satellite navigation system) can be used. Likewise, it would be possible to use already known methods with which mobile telephony networks are independently capable of determining the position of a mobile telephony terminal. If the position determination is effected not by the navigation terminal itself but by the mobile telephony network, the position data must be transmitted to the navigation terminal at certain intervals.

It is particularly advantageous if the calculated route is divided into route sections and the average travel speed is determined for each route section. This information can be included in the route calculation for other users of the method.

If announcements are made to the user by the navigation terminal, the driver can concentrate on the road and is not distracted by a visual display. The announcements and the position at which the respective announcement is made are transmitted to the navigation terminal by the central computer.

In the case of a particularly preferred method variant, when a defined announcement or route position is reached, a connection is established between the navigation terminal and the central computer and announcement texts and position markers are transmitted to the navigation terminal by the central computer. Provision can be made in this case whereby the central computer recognizes, on the basis of the position of the navigation terminal, that new announcement texts have to be transmitted to the navigation terminal, and transmits these automatically. Alternatively, provision can be made whereby the navigation terminal requests announcement texts and position markers from the central computer, which are thereupon transmitted.

Once the announcement memory of the navigation terminal is full, it accepts no further announcements from the central computer. In the course of the journey, after several announcements have been made and deleted, the navigation terminal again contacts the central computer. In this case, the navigation terminal logs on with its identity and requests further announcement texts and associated position markers, i.e., defined positions of the route at which an announcement is to be made. The announcement texts and associated position markers are stored in the terminal.

In a development of the method variant, the average travel speed for a route section is simultaneously transmitted to the central computer during a connection of the navigation terminal to the central computer. The central computer stores this data which is transmitted by navigation terminals of several users and continuously determines from it the average speed travelled on all route sections of the entire road network. This information can thus be included in the route calculation for other users of navigation terminals.

A particularly secure and rapid transmission of individual items of information is assured if the communication between the navigation terminal and the central computer is effected in packets. Modern mobile telephony networks such as GPRS and UMTS can be used in this case.

A particularly advantageous method variant has the special merit that the information transmitted by the navigation terminal is used to calculate travel routes for other users and/or compile statistics.

In a further aspect, the object is achieved, according to the invention, by a navigation system, particularly for vehicles, with means for position determination, a navigation terminal comprising an operating facility, a display facility, an announcement memory and a transmitter/receiver and being connected, at least intermittently, to a central computer via data transmission means.

A navigation system with such a navigation terminal is particularly cost-effective since there is no need for data on the traffic network (road maps) to be stored in the navigation terminal. The navigation terminal therefore does not require a reading device for a data medium which contains this information. This allows a constructional design which saves both space and cost in comparison with conventional navigation systems or navigation terminals. The navigation terminal comprises an announcement memory in which announcement texts for defined route sections are stored. Once the end of a section is reached, an announcement, giving instructions to the user, is automatically made by the navigation terminal. In this case, the respective announcement is made from the announcement memory as an acoustic output only. This does not require a connection to the central computer. Since the user is guided exclusively by the announcement texts, a small, low-cost display unit can be used. In particular, a display unit such as is commonly used in WAP-capable mobile telephones, can be used. This display unit is mainly required for selecting the travel destination. An essential difference from conventional navigation systems consists in the fact that the central computer derives information on the current traffic situation exclusively from the navigation terminals. The extremely high costs for the establishment and maintenance of a global-coverage network of sensors on roads and at traffic intersections are thus avoided entirely. All navigation terminals provide the navigation system with information on the current traffic situation. This information relates to the entire route network. It thus also includes secondary routes. The means for position determination can be designed as, for example, a GPS receiver provided on the navigation terminal. Alternatively, the position can be determined via mobile telephony networks, particularly if these are used as data transmission means.

If a vehicle mounting set is provided for the navigation terminal, vehicles can be retrofitted particularly easily and cost-effectively. The navigation terminal is mobile and can also be used in several different vehicles. Since no modification of the vehicle is required, such a navigation system can be retrofitted without difficulty.

In the case of a preferred embodiment, a modified mobile telephone is provided as a navigation terminal. Thus, in addition to the navigation function, the navigation terminal can also be used as a normal mobile telephone both outside and inside the vehicle.

In the case of a development, a hands-free device can be provided for the mobile telephone. The hands-free device enables the user to telephone safely while driving and to use the navigation terminal for two functions, firstly, for navigating and secondly, for telephoning.

If the navigation terminal is provided with a memory unit for storing a software for speech synthesis, the required announcement memory can be realized as a small, cost-effective memory.

A mobile telephony network and/or a gateway to the internet and/or the internet can be provided as means for data transmission. Thus, already existing communication systems can be used for communication between a navigation terminal and a central computer, rendering the construction of a navigation system according to the invention particularly cost-effective. Using the internet, it is also conceivable to construct a system in which interested parties can obtain information on the current traffic situation before setting out on the journey, e.g. by means of a PC and internet browser.

In the case of a preferred embodiment, a server is provided as a central computer, in which a list containing location information is stored. If a list containing location information is stored in the server, it is then not necessary for this list to be stored in the navigation terminal, so that the navigation terminal can be produced in an even more cost-effective manner. The data can be continuously updated in a central server, so that all users of a navigation terminal have continuous access to current data and information. Statistical information on the travel behaviour, as well as the utilization of the traffic network, can be collected and evaluated in the server. This information can be evaluated by, for example, traffic planners for the purpose of planning optimum locations for roadside service areas and other facilities.

### BRIEF DESCRIPTION OF THE DRAWINGS

Further advantages of the invention are disclosed by the description and the drawing. Equally, according to the invention, the above-mentioned features and those stated in the following can each be applied singly per se or in multiples, in any combinations. The embodiment which is represented and described is to be understood not as a definitive specification but, rather, as being of an exemplary nature for the purpose of describing the invention.

The invention is represented in the drawing and explained more fully with reference to an embodiment example, wherein:

FIG. 1 shows a schematic representation of a navigation system according to the invention; and

FIG. 2 shows a highly schematic representation of a navigation terminal.

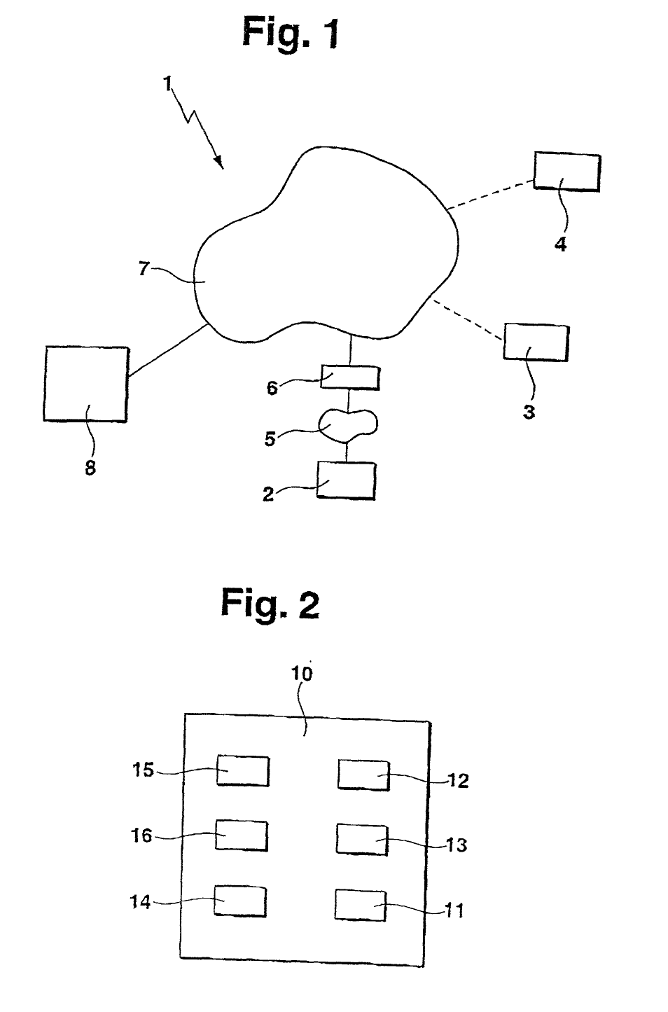

FIG. 1 shows the schematic representation of a navigation system 1. Several navigation terminals 2 to 4 are connected, via a mobile telephony network 5 and a gateway 6 to the internet 7, to a central computer 8 in the form of a server. The user selects a travel destination from a list, via a navigation terminal. The list containing travel destinations can be stored either in a navigation terminal 2 to 4 or in the central computer 8.

A navigation terminal is represented schematically in FIG. 2. The navigation terminal 10 comprises a display facility 11 via which a travel destination can be selected by means of a touch-screen or an operating facility, not represented. When a travel route has been selected, announcement texts for defined route sections are transmitted to an announcement memory 12 by the central computer 8. The announcements stored in the announcement memory 12 are converted into speech by a speech synthesising software 13. The current position of the navigation terminal 10 is determined by a GPS receiver 14. The navigation terminal 10 can also be used for telephoning, by means of a mobile telephony part 15. A hands-free device 16 can be used for telephoning during travel.

The functioning of the navigation system according to the invention is described more fully with reference to an example. A user specifies his travel destination via the display device 11 of the navigation terminal 2 to 4, 10. For this, he selects a place name, a street and, possibly, a house number from a list. This list is stored either in the navigation terminal 2 to 4, 10 or in the central computer 8. The navigation terminal 2 to 4, 10 transmits the desired travel destination and the current location to the central computer 8. The current location is determined by the GPS receiver 14.

The central computer 8 calculates one or more route(s) and the expected travel time requirement. In calculating the route and the travel time, the central computer 8 uses the stored data on the traffic network and information on the current traffic situation which the central computer 8 has already received from other navigation terminals 2 to 4, 10.

The route and travel time are transmitted, as an announcement, to the navigation terminal 2 to 4, 10, where they are stored in the announcement memory 12. The announcements can be listened to by the user. If several equally good routes are determined, the user can select one of the routes. Prior to the calculation of a route, the user can also make additional specifications, e.g. that motorways are to be avoided.

The central computer 8 divides the calculated route into route sections. At the end of a route section, the user must obtain information on the further course of the route. The information is supplied to the user via announcements which are stored in the announcement memory 12 and output by means of the speech synthesising software 13. These announcements and the route position at which the respective announcement is made are transmitted to the navigation terminal 2 to 4, 10 by the central computer 8. Once the announcement memory 12 of the navigation terminal 2 to 4, 10 is full, the navigation terminal 2 to 4, 10 accepts no further announcements from the central computer 8. A connection is established between the navigation terminal 2 to 4, 10 and the central computer 8 when several announcements have been made and deleted. Further announcement texts and associated position markers are then requested for the subsequent route sections and stored in the announcement memory 12.

The current position of the navigation terminal 2 to 4, 10 is determined at short intervals by means of the GPS receiver 14. When a determined position coincides with a position marker, the announcement stored in the announcement memory 12 for this position marker is made automatically. In this case, the respective announcement is made from the announcement memory 12 as an acoustic output only. This does not require a connection to the central computer 8.

For each completed route section, the navigation terminal 2 to 4, 10 determines the average travel speed from the elapsed time and the distance travelled. At certain intervals of time, or upon reaching defined route points, the navigation terminal 2 to 4, 10 again requests announcements and associated position markers from the central computer 8. When the necessary connection exists, the determined average speeds for the completed route sections are simultaneously transmitted to the central computer 8. The central computer 8 stores this data and from it continuously determines the average speed travelled on all route sections of the entire road network.

1. Method for navigating by means of a user-side navigation terminal, particularly of vehicles, in which such a navigation terminal is located, with the following method steps:
a. selection of a travel destination from a list via the navigation terminal;
b. transmission of the selected travel destination and of the current location to a remotely located central computer;
c. calculation of one or more travel route(s) and/or the corresponding travel time;
d. transmission of the travel route and/or the travel time from the central computer to the navigation terminal.

2. Method according to claim 1, wherein the travel route is calculated with regard to conditions entered in the navigation terminal by the user.

3. Method according to claim 1, wherein the position of the navigation terminal is determined and/or the calculated route is divided into route sections and the average travel speed is determined for each route section.

4. Method according to claim 1, wherein announcements are made to the user by the navigation terminal and, when a defined announcement or route position is reached, a connection is established between the navigation terminal and the central computer and announcement texts and position markers are transmitted to the navigation terminal by the central computer.

5. Method according to claim 4, wherein, simultaneously during the connection of the navigation terminal to the central computer, the average travel speed for a route section is transmitted to the central computer and/or the communication between the navigation terminal and the central computer is effected in packets and/or the information transmitted by the navigation terminal is used to calculate travel routes for other users and/or generate statistics.

6. Navigation system, particularly for vehicles, with means for position determination, a navigation terminal comprising an operating facility, a display facility, an announcement memory and a transmitter/receiver and being connected, at least intermittently, to a central computer via data transmission means.

7. Navigation system according to claim 6, wherein a modified mobile telephone is provided as a navigation terminal and a hands-free device is preferably provided for the mobile telephone.

8. Navigation system according to claim 6, wherein a memory unit for storing a software for speech synthesis is provided for the navigation terminal.

9. Navigation system according to claim 6, wherein a mobile telephony network and/or a gateway to the internet and/or the internet is/are provided as a means for data transmission.

10. Navigation system according to claim 6, wherein a server is provided as a central computer, in which a list containing location information is stored.
